(19) United States
(12) Patent Application Publication
(10) Pub. No.: US 2007/0212597 A1
(43) Pub. Date: Sep. 13, 2007

(54) Insulated smart battery pack for low temperature applications

(75) Inventor: Gerry Herlinger, Bolton (CA)

Correspondence Address: HARNESS, DICKEY, & PIERCE, P.L.C, 7700 BONHOMME, STE 400, ST. LOUIS, MO, 63105, US

(73) Assignee: Psion Teklogix Inc., Mississauga (CA)

(21) Appl. No.: 11/372,163

(22) Filed: Mar. 9, 2006

(51) Int. Cl. H01M 10/50; H05B 1/02

(52) U.S. Cl. 429/62; 429/120; 219/494

(57) ABSTRACT

A battery heater for heating a battery of a hand-held electronic device is provided. The heater comprises a flexible substrate having a first and a second side, at least one heating element on the first side, a layer of insulating material adjacent to the second side, a controller for controlling the operation of the heating element, the controller receiving input from a temperature measuring means, and a battery power measuring means.

### FIELD

The present invention generally relates to batteries and more particularly relates to batteries for low temperature application.

### BACKGROUND

It is known that there can be a significant decrease in available power from a battery at temperatures below 0° C. The magnitude of this decrease and the temperature at which it becomes significant varies with the particular battery type. In the case of Li-ion cells this decrease becomes significant at temperatures below −20° C. Therefore in applications that require system operation at temperatures below −20° C. a decrease in available battery power is experienced. This will generally result in reduced productivity and may result in increased system costs. With regard to the latter point this encompasses the possible requirement for additional equipment to compensate for the reduced power from a given battery.

FIG. 1 presents a graph illustrating the power decrease that is associated with sub-zero temperatures for Li-ion battery cells. Namely there is a decrease in the available power of approximately 6% when the temperature is about −10° C. The power decrease jumps to approximately 70% when the temperature drops to −30° C. It has also been determined that power availability restored when the temperature is subsequently elevated.

In cases of cold temperature operations such as in a freezer the decrease in available power may result in work interruptions for the employees that are using the system and may include both a need to replace the devices or the battery contained therein on a more frequent basis, reduced shift time for the personnel or reduced overall lifetime for the battery, all of these factors represent additional costs to the battery user.

One approach to reduce the loss of available power is to raise the temperature of the battery. The use of battery heaters during operation of the battery in low temperature conditions is known in the art. The systems may be applicable to vehicle batteries as described in U.S. Pat. Nos. 6,029,762 to Kepner, 5,948,298 to Ijaz and 3,594,547 to Quinn or they may be applicable to hand held devices as described in U.S. Pat. No. 6,575,156 to MacFarlane et al. or Japanese patent JP5020861 of Hiromoto. In the latter two patents the disclosed system is a “dumb” system that either uses an external energy source for the heating or simply provides insulation around the battery pack to retain the heat generated during charging and discharging of the battery.

While the above systems are “dumb” in the sense that they are not actively controlled, systems that implement a controller have also been disclosed. U.S. Pat. No. 5,834,131 to Lutz et al. discloses a system that includes a temperature sensor disposed adjacent to the battery cells for monitoring the temperature of the cells. The heating system implements resistive heating elements, where these elements are operated when the temperature of the cells is below a predetermined temperature.

Japanese patent JP61074270 of Shigefumi discloses a control system for a vehicle battery. The system includes battery electrolyte, battery case and surrounding air temperature sensors. Heat is applied to the battery such that the output of the battery is maintained at a constant level. The application of heat considers the current temperatures and a performance index of the battery.

Therefore there is need for a system that can heat the battery in a “smart” manner that is suited to the form factor associated with a hand-held device.

### SUMMARY

The present invention relates to battery system that incorporates a heater, insulation and control method wherein the battery is heated to extend the battery lifetime at low temperature operation.

It is an object of the invention to provide an improved battery system that is applicable to low temperature application.

According to an aspect of the invention a battery system for a hand-held electronic device is provided. The battery system comprising a battery, a heater surrounding the battery, a layer of insulating material surrounding the heater wherein the insulating material provides a thermal barrier around the heater, a temperature measuring means adjacent to the battery, a power level measuring means for measuring the power level remaining in the battery, and a micro-controller for controlling the operation of the heater, the micro-controller receiving input from the temperature measuring means and the power level measuring means and calculating an amount of heat to be applied by the heater based on the received input.

According to another aspect of the invention a battery heater for heating a battery of a hand-held electronic device is provided. The heater comprises a flexible substrate having a first and a second side, at least one heating element on the first side, a layer of insulating material adjacent to the second side, a controller for controlling the operation of the heating element, the controller receiving input from, a temperature measuring means, and a battery power measuring means.

According to another aspect of the invention a method of heating a battery of a hand-held electronic device during operation of the hand-held device is provided. The method comprising the steps of determining a battery temperature, providing power to a heater to initiate heating of the battery if the battery temperature is below a specified value, determining an amount of remaining power in the battery, reducing the power provided to the heater if the amount of remaining power is low, determining the battery temperature, and continuing to provide power to the heater if the battery temperature is below the specified value.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 presents a graph of the decrease in power with temperature;

FIG. 2a presents and end view of battery cells and the battery heater system in accordance with a further embodiment of the present invention;

FIG. 2b presents a side view of the battery heater system in accordance with a further embodiment of the present invention;

FIG. 3a shows a cross section through the battery heater and insulation according to a further embodiment of the present invention;

FIG. 3b shows a plan view of the battery heater in accordance with a further embodiment of the present invention; and

FIG. 4 a flowchart of a method of operating the battery heater system in accordance with a further embodiment of the present invention.

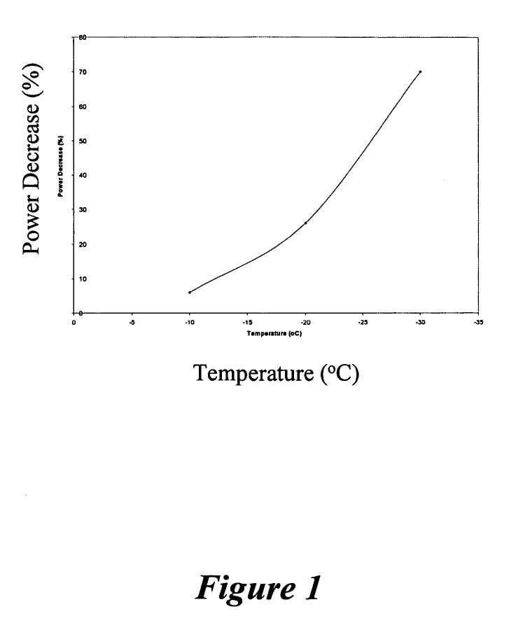

### DETAILED DESCRIPTION

The following description is of a preferred embodiment.

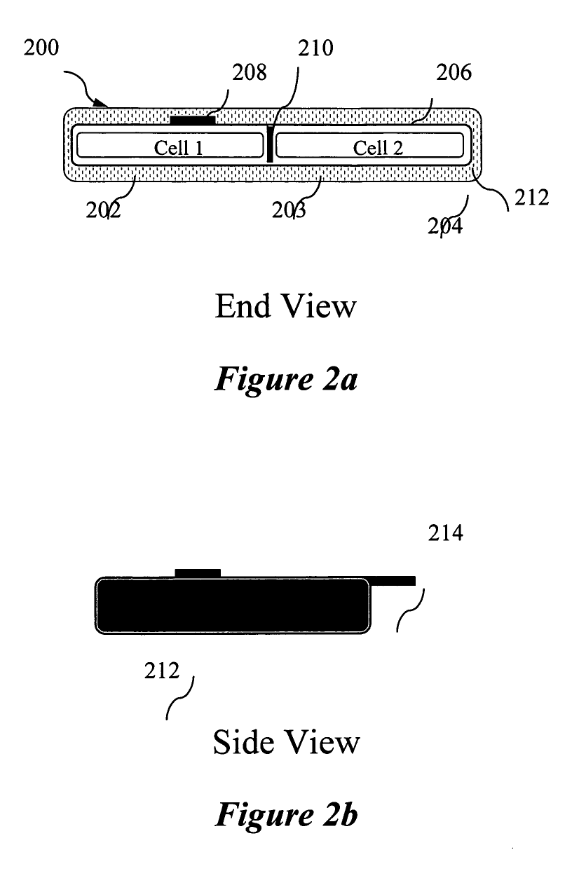

A schematic diagram of a battery heating system 200 according to an embodiment of the present invention is shown in FIG. 2a. The battery heating system 200 is used to manage the temperature of the battery cells 202 and 203. In this embodiment the cells 202 and 203 are Li-ion cells as is commonly used for hand-held electronic devices. The cells 202 and 203 are rechargeable. A heater 206 is placed adjacent to the cells 202 and 203. The heater 206 is shown as a continuous loop for simplicity in FIG. 2. However, the heater 206 has two ends thereof. Insulation 204 is then wrapped around the heater 206. In the current embodiment the insulation 204 is Thinsulate®. Generally the insulation 204 should be quite thin while providing a high R value (low thermal conductivity). Further the insulation will generally be in the form of a synthetic material. Other materials that provide the required thermal properties will be apparent to one skilled in the art.

Integrated circuit 208 is affixed to the heater 206. The circuit 208 provides the logic for determining the amount of heat to be applied by the heater 206. Thus the circuit 208 provides micro-controller functionality for the control of the heating elements. The circuit 208 receives temperature data from a temperature measuring means 210 as an input thereto. In the current embodiment the means 210 is a thermocouple that is operative at the temperature range in question. It will be apparent to one skilled in the art that any temperature sensing means applicable to the temperature range that may be experienced during operation is within the scope of the invention.

While there is only one integrated circuit 208 illustrated in FIG. 2 the invention is in no ways limited to a single integrated circuit. Rather the invention encompasses all integrated circuits and discrete components that are required to control the heater as discussed herein.

FIG. 2b presents a side view of the battery heating system 200 with the side 212 being used as a reference. Contacts 214 are connection points from the heater 206 to the battery pack contacts located on the outside of the battery pack casing. The contacts 214 can be attached directly to the battery pack contacts or flexible wiring may be used between the two depending on battery pack construction.

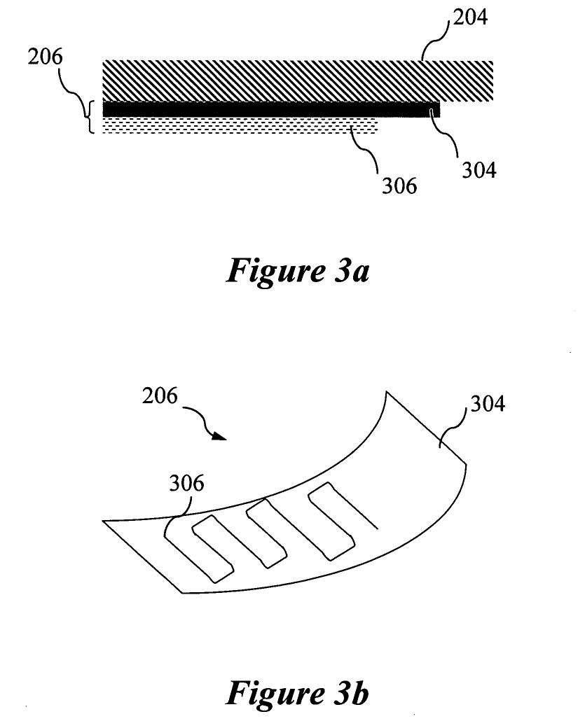

Further detail of the heater 206 is presented in FIGS. 3a and 3b. FIG. 3a presents a cross-section through the insulation 204 and the heater 206. The heater 206 includes a substrate 304 and heating element 306 where the heating element 306 is bonded to the substrate 304. The heating element 306 does not form a continuous layer over the substrate 304. Rather the heating element will generally have the shape of a wire, which is shaped to form a desired pattern. The heating element 306 may be fabricated using print-etch techniques as would be apparent to one of skill in the art.

A schematic plan view of the heater 206 is presented in FIG. 3b. The flexibility of the substrate 304 is illustrated in this figure. In the current embodiment the heater 306 is shaped to form a serpentine pattern on the substrate 304. The invention is by no means limited to this shape of the heating element 306. Other patterns of heater 306 on the substrate 304 are within the scope of the invention.

In wrapping the heater 206 around the battery cells 202 and 203 it is not fixed in position. Rather it can change dimensions to accommodate a shape change of the battery cells 202 and 203 associated with the charging and discharging thereof. The insulation 204 is also capable of accommodating a shape change. This accommodation means that relief pockets do not have to be used in the design of the battery system.

FIG. 3b presents a perspective plan view of the heater 206. FIG. 3b presents an example of the pattern of the heating element 306. In this example the heating element forms a serpentine pattern over the surface of the substrate 304. As will be apparent to one skilled in the art FIG. 3b presents a representation of a possible pattern and does not present all connections made to the heating element 306. The heating element 306 is located on the side of the substrate 304 opposite that of the integrated circuit 208 and any other electrical components that are required for control of the heater.

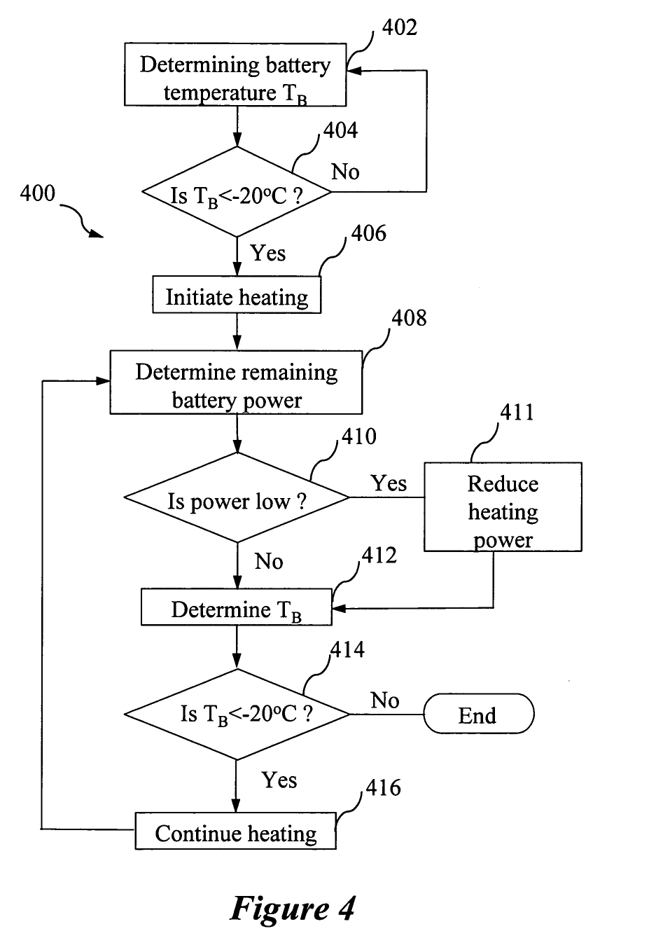

A flowchart of a method of operating the battery heating system 200 according to an embodiment of the invention is shown in FIG. 4. The method of FIG. 4 is performed during operation of the hand-held device i.e. power is being drawn from the battery. At step 402 the temperature of the battery T_{B} is determined. This temperature may in fact be the temperature on the outside of the battery cells as this is a convenient location for placement of the temperature sensing means 210. At step 404 it is determined whether or not the temperature of the battery is less than −20° C. If the battery temperature is less than −20° C. heating is initiated at step 406. If the answer at step 404 is no the process returns to step 402.

At step 408 the power that is remaining in the batteries is determined. If the power is determined to be low at step 410 the heating power is reduced at step 411. If the power is not determined to be low at step 410 the temperature of the battery T_{B} is again determined at step 412. After the heating power is reduced at step 411 the process also proceeds to step 412. At step 414 it is determined whether the T_{B} is less than −20° C. If the temperature is above −20° C. the process ends. Else heating is continued at step 416 and the process returns to step 408.

The method 400 can be applied in at least two different modes. In the first mode heat is applied on a near continuous basis to maintain the battery in preferred operating conditions with regard to battery life. In the second mode the method may be operated in an intermittent pattern to address power requirements for specific functionality of the hand-held device. Namely the method may be operated to ensure that voltage ‘dipping’ does not occur when the cells are cold and high current pulses are required for uses such as radio transmission. In both of the above modes the temperature of the battery must be below −20° C. Above −20° C., the heating circuit is disabled. It has been found that there is a large decrease in available power for temperatures below −20° C. for Li-ion batteries of the current embodiment. It will be apparent to one skilled in the art that the threshold temperature for the operation of the system is a function of the battery that is being used.

Finally as noted the method 400 would only be operative during device operation. In this case the battery heating system would enter a “sleep” mode when not in use.

The present invention has been described with regard to one or more embodiments. However, it will be apparent to persons skilled in the art that a number of variations and modifications can be made without departing from the scope of the invention as defined in the claims.

What is claimed is:

1. A battery system for a hand-held electronic device, the battery system comprising:
a battery;
a heater surrounding the battery;
a layer of insulating material surrounding the heater wherein the insulating material provides a thermal barrier around the heater;
a temperature measuring means adjacent to the battery;
a power level measuring means for measuring the power level remaining in the battery; and
a micro-controller for controlling the operation of the heater, the micro-controller receiving input from the temperature measuring means and the power level measuring means and calculating an amount of heat to be applied by the heater based on the received input.

2. The system according to claim 1 wherein the micro-controller is an integrated circuit.

3. The system according to claim 1 further comprising a printed circuit board having a first and a second side, the heater being located on the first side.

4. The system according to claim 3 wherein the micro-controller is an integrated circuit located on the second side.

5. The system according to claim 1 wherein the insulation is a layer of synthetic insulative material.

6. The system according to claim 1 wherein the battery is a Li-ion battery.

7. A battery heater for heating a battery of a hand-held electronic device, the heater comprising:
a flexible substrate having a first and a second side;
at least one heating element on the first side;
a layer of insulating material adjacent to the second side; and
a controller for controlling the operation of the heating element, the controller receiving input from:
a temperature measuring means; and
a battery power measuring means.

8. The system according to claim 7 wherein the micro-controller is an integrated circuit.

9. The system according to claim 8 wherein the micro-controller is an integrated circuit located on the second side.

10. The system according to claim 7 wherein the insulation is a layer of synthetic insulative material.

11. A method of heating a battery of a hand-held electronic device during operation of the hand-held device, the method comprising the steps of:
determining a battery temperature;
providing power to a heater to initiate heating of the battery if the battery temperature is below a specified value;
determining an amount of remaining power in the battery;
reducing the power provided to the heater if the amount of remaining power is low;
determining the battery temperature; and
continuing to provide power to the heater if the battery temperature is below the specified value.

12. The method according to claim 11 wherein the specified value is −20° C.

13. The method according to claim 11 wherein the power remaining in the battery is considered low if it is less than 25% of a maximum stored power.
